(19) United States
(12) Patent Application Publication
(10) Pub. No.: US 2020/0134557 A1
(43) Pub. Date: Apr. 30, 2020

(54) LOGISTICAL SERVICE FOR PROCESSING MODULAR DELIVERY REQUESTS

(71) Applicant: Quisto Company Limited, Nicosia (CY)

(72) Inventors: Boris Pevzner, New York, NY (US); Felix Lubashevskiy, Moscow (RU); Evgeniy Konshin, Moscow (RU); Evgeniy Kolodkin, Moscow (RU); Dmitry Dovgal, Moscow (RU); Denis Turinge, Vilnius (LT); Alexander Kazeev, Vilnius (LT); Alexander Tcygantcev, St. Petersburg (RU)

(21) Appl. No.: 16/670,454

(22) Filed: Oct. 31, 2019

Related U.S. Application Data
(60) Provisional application No. 62/753,257, filed on Oct. 31, 2018.

(51) Int. Cl. G06Q 10/08; G06Q 10/10; G06Q 10/06; G06N 20/00

(52) U.S. Cl. CPC G06Q 10/0834; G06Q 10/1097; G06F 16/2465; G06N 20/00; G06Q 10/06315

(57) ABSTRACT

A system and method (referred to as a system) schedules vehicles transporting freight on a mesh network using a machine learning process. The system receives transportation requests over a network from a plurality of customer portals that include loading times, loading locations, destination locations, delivery times, and freight requirements. The system mines large data sets from remote sites that reflect distances between the loading locations and the destination locations and corresponding freight rates associated with distances through the machine learning process. The system predicts shipping schedules that include predicted departure time and a predicted arrival time associated with the plurality of shipping schedules. The system matches the transportation requests with the plurality of shipping schedules in real time based on a plurality of shipping preferences, carrier availabilities, and projected probabilities that a plurality of carriers will accept loads.

### RELATED APPLICATION

This application claims priority to provisional application of Ser. No. 62/753,257 filed on Oct. 31, 2018, titled “System, Method and Architecture for Processing Modular Requests for Delivery,” which is herein incorporated by reference in its entirety.

### BACKGROUND OF THE DISCLOSURE

### 1. Technical Field

This disclosure relates to transport, and specifically to the logistics of moving freight.

### 2. Related Art

Over the road transport is challenging. Shippers, freight brokers, and carriers move freight by linking carriers to shippers, and carriers and shippers must stay in touch. This means that agreements must be reached before loads are picked up, and confirmations must verify that the loads are picked up and delivered on time.

Freight movement is typically judged by supply and demand. A transport system is effective if it meets the need at an expected cost. That cost is then passed on to consumers. Current systems fail to consider transport efficiency or respond to changes in transport environments. The systems fail to provide sufficient notice to shippers, freight brokers, and carriers that is usually needed to deliver freight on-time.

### BRIEF DESCRIPTION OF THE DRAWINGS

The disclosure is better understood with reference to the following drawings and description. The elements in the figures are not necessarily to scale, emphasis instead being placed upon illustrating the principles of the disclosure. Moreover, in the figures, like-referenced numerals designate corresponding parts throughout the different views.

FIG. 1 is a diagram of a transport system.

FIG. 2 is a partial diagram of a second transport system.

FIG. 3 is partial block diagram of the second transport system.

FIG. 4 is a process flow of an agent interaction.

FIG. 5 is a price-finder interface page.

FIG. 6. is a process flow of a pricing algorithm

FIG. 7 is a diagram of a third transport system.

FIG. 8 is a diagram of a fourth transport system.

FIG. 9 is a diagram illustrating a data integration.

### DETAILED DESCRIPTION

The disclosed systems and methods (referred to as transport systems) efficiently automate the logistics that move freight. The transport systems coordinate complex delivery routes that may include intermodal transport that moves freight over the road, over rails, across the water, and/or through the air (e.g., planes, trains, trucks, and boats). The transport systems optimize deliveries across one or more modes of transport and construct one or more transport options through one or multiple delivery legs. The development of the logistics behind the transport system is based on productivity and efficiency that ensures safe and cost-effective deliveries in a cost efficient and a time-sensitive schedule. The effectiveness and performance of the transport systems impact the productivity and competitiveness of businesses, as well as the prices customers pay for goods and services.

The transport systems generate an environment that provides access to programs, files, and options via innovative interfaces. Through icons, menus, and dialog boxes, shippers, freight brokers, carriers, and other users can select automated shipping options or accept automated recommendations (e.g., highlighted on a price-finder interface). Multiple elements may be included in the innovative interface (referred to as an interface), such as a market awareness panel, for example, that functions the same way in all software applications, because the element provides the same functionality to the end users via software routines that reside above the system software and automatically adapt to changes in computing environments without user involvement. Different software applications call these elements (e.g., software routines) with specific parameters rather than reproducing the software code from scratch allowing the computer systems that delivers these systems to operate more efficiently. Further, the interfaces and elements are device independent, meaning that as new input data is received, different users access the interfaces, and/or computer architectures changes, the interfaces and elements adapt and provide consistent functionality without user involvement. The transport systems and integrated applications run, without modification, on any device and are extensible. Further, in some systems, the disclosed transport systems are device and operating system agnostic, which increases the accessibility of the system to local and remote distributed users.

The innovative interfaces include a price finder user interface that can reflect pricing rendered via a price finder matrix across different modes of transportation (a full truck load (FTL), less than truck load (LTL), Intermodal, etc.). The price finder user interface can also generate forecasts that render time and/or price tradeoffs, provide information regarding special-circumstance pricing (e.g., such as backhauls, contract-based pricing for some lanes, container repositioning, etc.), and provide appointment price tradeoffs, including working around the hours of service restrictions, for example.

In the disclosed system, a broker agent module 102 automatically assists shippers with freight ready to or predicted to haul by finding carriers who are qualified to haul their loads. The broker agent module 102 makes it easier to broker agreements between shippers and carriers that facilitate the movement of the shippers' freight. In some extensions, the broker agent module 102 through a freight visibility module 248 maintains real time communication with the carrier agent module 104 to track and update the motor carrier's status, direction of travel, and progress of the shipper's load to its delivery destination that may be rendered on geographic real time maps. Real time operations are those in which the machine's activities (e.g., the freight visibility module 248, for example, tracking of the motor carrier's movement) exceed the user's perception of time or those in which the computer processes input data within milliseconds (preferably less than about 100 milliseconds) or at a faster rate so that its output is available virtually immediately as feedback.

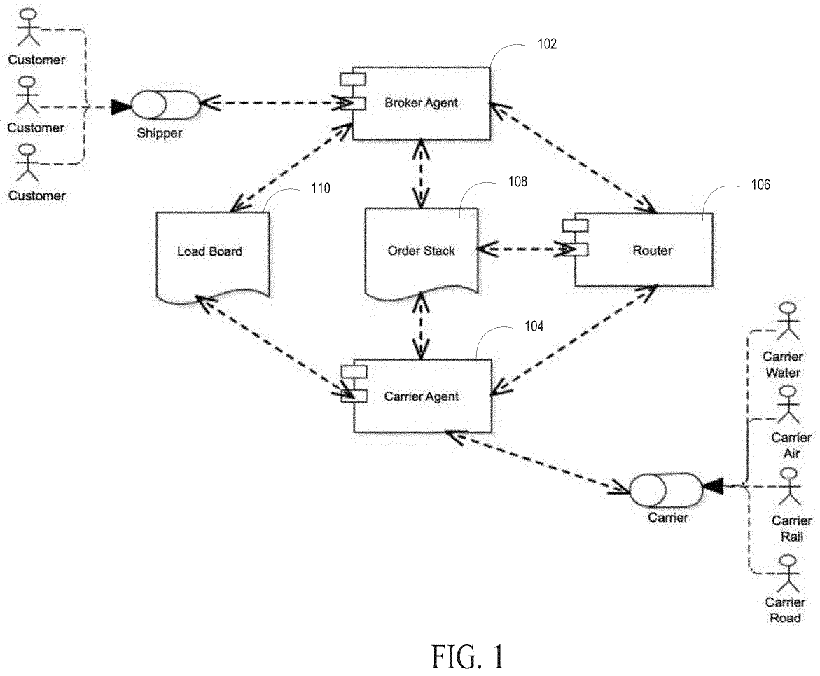

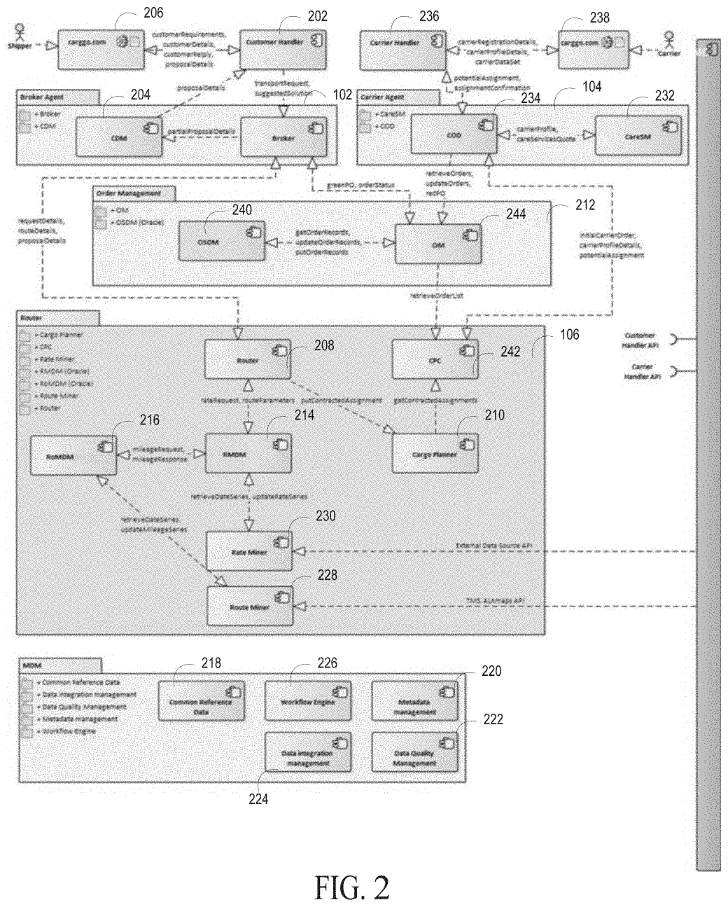

With reference to FIGS. 1 and 2, the broker agent module 102 receives transportation requests and suggested solutions from a shipper interface (shown as a customer interface in FIG. 2) 202. Through a customer data modeler 204, freight delivery proposals are received in response to a shipper's order (sometimes referred to as a green purchase order) and the details of the proposal retuned to the customer portal 202, through a web interface 206, which is the portal that the transport system interacts with shippers. Delivery proposals are generated at a freight router module 208 and a cargo planner module 210. A request for route detail and proposal details are received by the freight router module 210 on a communication network that expedites message delivery between the broker agent module 102 and the router module 106.

In FIG. 2, networks link many modules through mesh connections. The freight router 208 receives transmitted messages and forwards them to their desired destinations over most efficient and available communication route. A routing table or a set of rules, determines where and how the data packets can and will travel across a network, meaning the routing table is dynamic and changes with the network in real time in some systems. Between the master data management modules 214 and 216 and the cargo planner module 210, is the freight router 208 that also serves as the device connecting the broker agent module 102 to the cargo planner module 210.

The master data management modules 214 and 216 support data management by removing duplicates data entries, standardizing and normalizing data (mass maintaining), and executing rules that eliminate or prevent incorrect or corrupt data from entering the transport system. The master data management modules 214 and 216 render authoritative sources of master data in the transport system. The master data management modules 214 and 216 access processes that collect, aggregate, match, consolidate, quality-assure, persist, and distribute data improving the integrity and accuracy of the data. This functionality is enhanced by a common reference data repository 218, a metadata management module 220, a data quality management module 222, a data integration management module 224, and workflow engines 226. The workflow engines 226 manage and monitor the state of activities of the transport workflow, by linking of multiple modes of transport in some applications, and determining which transport mode to transition to according to pre-defined transport-flows, some being established by the carrier profiles), that can be downloaded and updated as the transport network changes.

In FIG. 2, one instance of the master data management module 216 in the router module 106 retrieves data sets on routes and mileages from a route miner module 228 and another instance of the master data management module 214 retrieves data series and rate series from a rate miner 230. The route miner module 228 and the rate miner module 230 identify and retrieve route and rate data and related data from databases and other computer data repositories through the use of statistical tools and models in response to rate and route requests received from the freight router 208. Pricing data may be mined from a plurality of external sources (such as local and/or remote pricing databases, shipper and broker transportation management systems, etc.), historical pricing data locally accessible to the transport system, and historical data provided by transport system users. By processing user data, the transport system can make customer-specific pricing forecasts. In some use cases, the transport system does not mix some users' data with other users' data—so that the transport system can process the data separately through different algorithms.

For example, the rate miner 230 may render a weighted average price in different transport regions. The price may be adjusted or filtered to render a forecasted price based on one or more filter factors (also referred to as the freight filters and freight filter factors) by the price algorithm. The filter factors may include one or any combination of adjustment factors that reflect: a predicted statistical confidence of the transport system to procure transportation, an expected equipment type to be used, a measure of supply and demand, adjustments for seasonal variations (e.g., the use of transport during harvest seasons), weekly variations (some prices vary by the day of the week), a desired profit margin and/or subjective criteria, such as a desire to grow or expand transport in a geographic area, transport facility attributes (some facilities load and off-load vehicles quickly and others are frequently delayed), pickup and delivery times during the day, urgency (e.g., must be picked up within twenty four hours), a team drive (e.g., the use of two or more drivers to deliver the freight), dimensions and weight of the shipment, number of stops in multi-pick/multi-drop shipments (described below), etc. Other system pricing is practiced in alternate system in the absence of (i.e., at the explicit exclusion of) any one or combination of the filter factors above and any price adjustment factors which are not specifically disclosed herein.

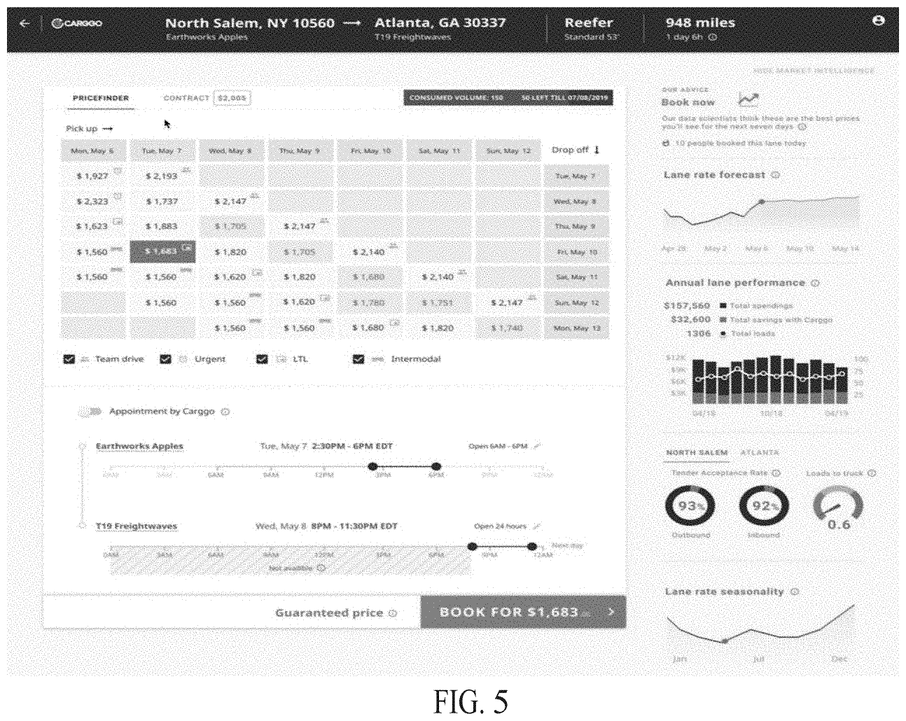

The freight router 208 calculates the distance between the points of origin and the destination, forecasts the average time it will take to travel that distance, and estimates the cost of delivery per mile. That data is transmitted to the broker-agent module 102 that calculates the total cost of the deliveries through different transport modes and time frames that is rendered on a price-finder interface such as the exemplary interface shown in FIG. 5. In some systems, the freight router 208 automatically recommends and/or process multimodal deliveries and generates routes including multiple sub-routes each with different modes of transport.

Transport transactions are processed in two stages through two independent and separate modules: the broker agent module 102 and the carrier agent module 104, which are linked together through an order stack 108 residing in the order management module 212 and a carrier contract profile 232 residing in the carrier agent module 104. In FIG. 2, potential carrier assignments are received by the carrier agent module 104 based on carrier orders and carrier profile details. Both are stored in the carrier order detail modules 234 that associates the carrier orders with the carrier profiles. The potential assignments and assignment confirmations are transmitted to the carrier portal 236, which is the port in the transport system that interacts with the carrier and may be web accessible 238.

Carrier assignments may be based on a number of criteria. For example, consider a use case in which a shipper does not have a time requirement for delivery but is price sensitive and another shipper that is time sensitive to delivery but is not price sensitive. Orders from shippers are stored in the order stack 108 in the order management module 212 and matched by the freight router module 208 and the cargo planner module 210. In another use case, carrier's cargo and route parameters are processed by the freight router module 208 and cargo planner module 210 when assigning potential carrier assignments to orders retrieved from the order stack. Route parameters may include loading times, loading locations, destination locations, delivery times, and freight requirements, for example. An external load board 110 may be used in alternate systems. External load boards 110 match carriers and shippers when a shipment is not otherwise assigned to a carrier.

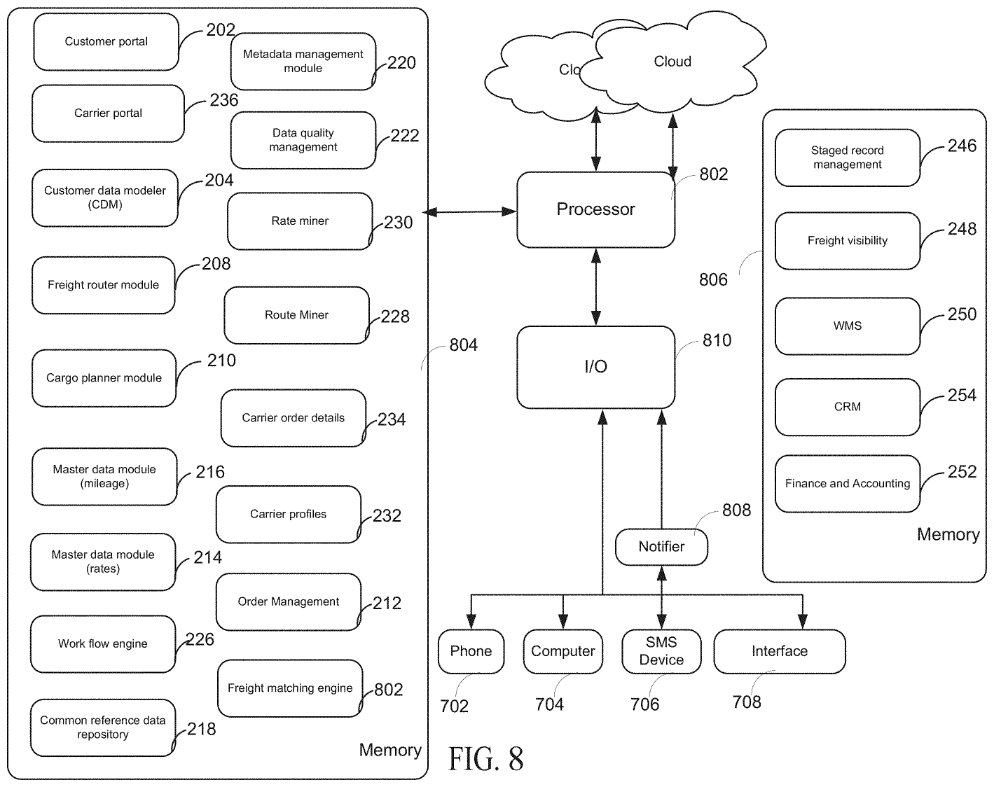

In some alternate systems, a freight matching engine 802 (shown in FIG. 8) automatically connects that carriers to the shippers and makes assignments without any manual intervention, which improves the efficiency and bandwidth of the system as it requires less network interactions. In an alternate system, the freight matching engine 802 makes assignments or recommendations to shippers with limited manual intervention. The matching is based on carrier and shipper profiles, datasets that reflect their preferences, route parameters, carrier availability, and/or in some systems, projected probabilities that a carrier will accept a load. Some probabilities may be based on historical performance of a carrier. An exemplary freight matching engine 802 renders a recommendation sequence as a function of carrier and shipper profiles, preferences, and route parameters in view of the carrier's availability. A recommendation sequence is rendered that identifies one or many carriers and the order and duration in which a potential assignment is proffered. Offers are then made (e.g., via a short message service, emails, automated calls, etc.) in the sequence the carriers are recommended until a carrier assignment is placed. When the transport system is coupled to the carrier and shipper networks, automated load-carrier matching occurs in nearly real time (analyzing data faster or nearly as fast as the rate it is received) in some alternate systems.

As orders are placed by the broker agent module 102, the order module 244 stores the orders, shipping documents, transport documents, and cargo documents via a structured query language developer data module (SDM) 240 in a database schema. The broker agent module 102 and carrier agent module 104 may access and monitor open orders and receive confirmations on closed orders. In FIG. 2, order lists, initial carrier orders, carrier profile details, route parameters, and potential assignments are accessible to the cargo planner module 210 through a central processing complex (CPC) 242 that also stores the contract assignments transmitted through the freight router.

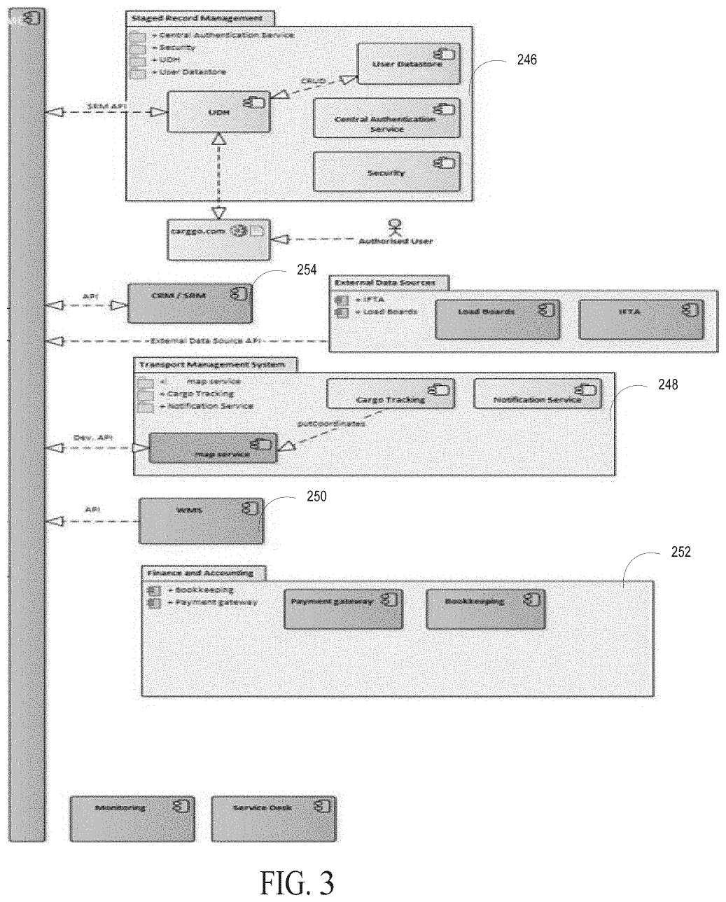

In FIG. 3, records may be stored in a stage record management module 246. Load boards 110 and the North American Transportation Association (NTA) site transmit external data and cargo tracking and notification services associated with a mapping service to a freight visibility module 248 in some systems. The freight visibility module 248 reports on the communication with a motor carrier to track and update the carrier's transport status, direction of the transport's travel, and progress of the shipper's load to its delivery destination in real time or near real time. The warehouse management system (WMS) 250 supports and optimize warehouse functionality and distribution center management. The WMS 250 systems facilitate management planning, organizing, staffing, directing, and controlling the utilization of available resources, to move and store freight into, within, and out of a warehouse or site, while supporting staff in the performance of material movement and storage in and around a warehouse. The payment gateway and bookkeeping modules 252 support the finance and accounting functions of the transport system. The customer relationship management (CRM) 254 technology manages the transport systems relationships and interactions with shippers, carriers, agent users. The CRM 254 technology allows the transport system to stay connected to users and streamline processes.

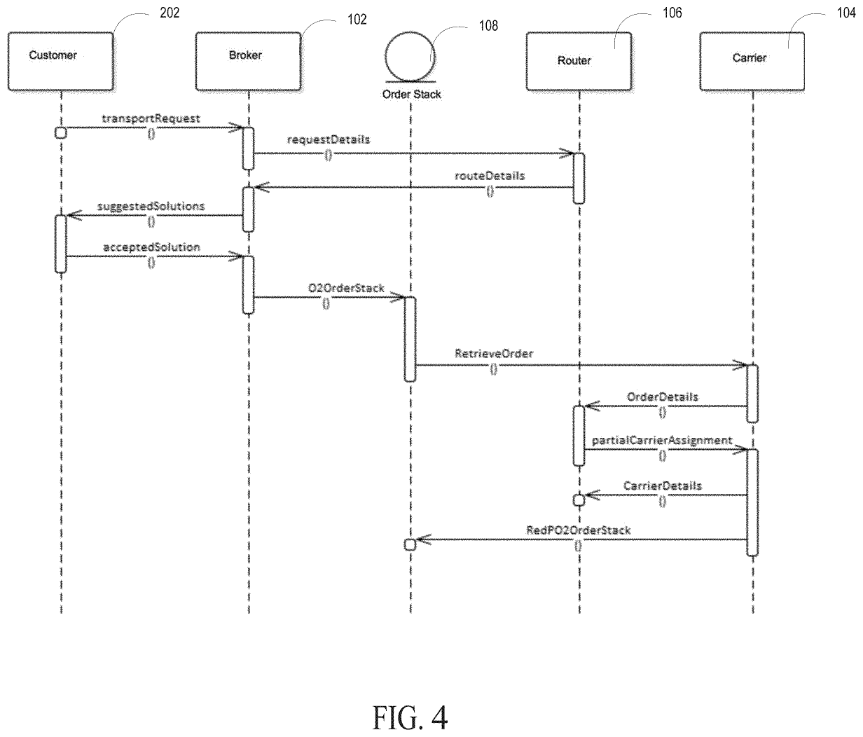

FIG. 4 illustrates an interaction that occurs through a customer portal 202 and a carrier portal 236. The interaction occurs when a shipper (e.g., an existing user or a new user) places a cargo delivery order and registers with the transport system. Here, the broker agent module 102 ensures that the order is complaint with predefined customer requirement rules before the order is stored in the order stack 108 by the transport system. The router module 106 receives the request and route detail and proposes assignments based on orders drawn from the order stack 108 through a freight matching engine 802 that draws qualified carriers based on carrier and shipper profiles, route parameters, and datasets that reflect their preferences, receptively, and carrier availability through a preferred sequence such as a first-in-first-out sequence. In some applications, the transport systems propose multi-leg routes in accordance with the selected carriers' profiles. The order module 244 generates and then stores orders, shipping documents, transport documents, and cargo documents in a database schema via the SDM 244 on the order stack 108. The potential assignments and assignment confirmations are transmitted to a first selected carrier via the carrier portal 236 (e.g., via one or more: a short message service, an email, automated phone call and/or, etc.), and when accepted, places and confirms the order. If a potential assignment is not accepted before the offer expires, the offer is proffered via the recommended sequence to the next carrier until a carrier assignment is made. With the order placed the carrier's progress from pick-up to delivery may be tracked through a cargo tracking and notification services 808 associated with a mapping service that is rendered in real time through the freight visibility module 248. Upon delivery, the payment gateway and bookkeeping modules 252 facilitate the collections and payments between the shipper and the carrier.

Some disclosed systems can provide a shipper with an instant price commitment (e.g., a guarantee) before a carrier assignment is made. The commitment is based on a weighted function of at least four parameters. In other use cases, more or fewer parameters are used. The parameters may include some or all of a vehicle/transport selection, its point of origination, the date of departure, the time of departure, a destination selection, the date of arrival, the time of arrival and/or the need for extra services. In a use case, the transport system provides a price commitment based on three parameters: a truck/vehicle selection, the point of origination selection, and the destination. The price commitment is devoid of any other parameters or factors. With these parameters, the transport system can provide an instant price commitment, and in some applications, automatically provide a counter offer (e.g., a subsequent proposal). In some examples, the system can transmit a counter or a subsequent price, automatically, in response to a rejection.

FIG. 5 illustrates a price finder user interface that can reflect four layers (or modes) of pricing rendered via a price finder matrix showing a pick up time and a drop off time. The layers include a full truck load (FTL) layer, a less than truck load (LTL) and an intermodal transport layer, a contract mode (K) layer, and a special circumstance layer that are generated by statistical models and machine learning systems, some of which are described herein. The prices reflect one or any combination of adjustment factors (e.g., the filter factors) described above and may specifically exclude those of which are not specifically disclosed herein to adjust a linehaul. A line haul is the cost of driving, fuel, and vehicle use for a shipping lane. A shipping lane refers to the operating routes served by a carrier. A dedicated shipping lane reduce waste by operating through consistent trips.

A full truck load (FTL) is a type of shipping mode in which a truck transports one dedicated shipment. It may be associated with a spot price meaning it is a dynamic rate that the transport system offers on the spot to move a load from an origin to a destination. Because it is based on market conditions, spot prices are shown to change over the course of a day via the price finder interface. FTL shipments occupy some or all of the entire weight or space capacity of the vehicle. Thus, FTL shipments are less encumbered by size and weight restrictions, often reach destinations sooner as there are less pickups and drop-offs (e.g., faster transit times because they are sent directly to destinations), and cargo is less susceptible to damage because it is subject to less freight handling as there are fewer transfers amongst vehicles in mid-transit. Base rates are generated from multiple data sources and are subject to the freight filters described here.

Less than truck load (LTL) combines the freight handling of many shipments in a common vehicle. It may also be associated with a spot price. LTL is used for transportation of smaller freight that does not require the use of an entire trailer or container. In the price finder matrix shown in the price-finder interface in FIG. 5, the shipper pays for the portion of the trailer or container that their freight occupies, without paying for the unoccupied space. In the price matrix, the shipment is priced based on the portion of the trailer or container that the shipper uses and are adjusted by the filter factors. Most freight are packaged on pallets before loading, making the freight more secure than small shipping products.

Within a window of time, there may also be some shipment orders that are either LTL or partial loads. The transport system's algorithms automatically consolidate such orders into a single FTL load to reduce cost and improve reliability in some applications. When consolidation occurs, a multistop FTL is created (via a multi-pick, multi-drop, or both). The same freight tracking/visibility and other freight execution automation technologies described herein are applied to such multistop loads. Further, the number of stops may also be reflected in one of the freight factors that adjust carrier pricing.

In intermodal transport, two or more modes of freight delivery are used to ship freight to its destination, with each mode of transport having its own carrier and its own agreement. In some use cases, railway, airfreight, and/or water transport systems are used, which may consume less fuel than if road transport were used exclusively. In the price finder matrix, the pricing algorithm is priced off of the railway, airfreight, and/or water transport schedules and also reflects spot prices. The algorithms factor in distances to terminals, drayage service, the expense of tracking two or more modes of transport, and the type of cargo such as whether it is perishables and/or hazardous, for example, that may be subject to restrictions or exclusions. When a customer's order (e.g., the shipper) qualifies for intermodal transport, meaning it meets the transport requirements in terms of shipping time, location, and types of cargo, the price-finder interface presents intermodal transport options and prices automatically when the interactive dynamic control associated with it is enabled. In FIG. 5, a check mark next to the intermodal option, the team-drive option, the urgent option, and the LTL options are enabled as shown by the checked boxes. The resulting prices are guaranteed as the prices are forecasted about two and three weeks out from a desired shipment date based on historical data and the freight filters.

Besides providing spot price processes, the transport system also offers contract and spot rates for users who have agreements for shipping lane. A contract price is the price that the transport system agrees to move a shipper's freight in a set of shipping lanes over a set period of time. A contract price also means that the transport system will assure the same freight type will reach its destination every time under some agreements. In the transport system, the contract price is rendered via another price-finder interface, which reports the amount of volume moved under the contract and the commitment yet to be met. Even when a commitment has not been met, the freight router 208, in some transport systems, may recommend a spot price when prices under the contract diverge from spot rates. In these use cases, the transport system monitors the customer's usage and forecasts the customer's future use. When projected volumes exceed the contract volume by a predetermined threshold and the spot rates fall below the contract price by a predetermined threshold, some router and cargo planner modules 208 and 210 recommend rates outside of the contract, which may result in a discount to the contract rate. This allows shippers to reduce spot market exposure by entering into contract prices, while taking advantage of spot market discounts when the spot market rates fall below contract prices.

Under the special circumstance mode layer, a freight router and cargo planner module 208 and 210 may recommend better pricing options that are not available on the open market. A better price opportunity may occur when the transport system services a contract price for a shipping lane. When a second, a third, or a fourth, or any number of customers enter the same origin and destination or an origin and destination within a threshold radius of its contract locations, the router and cargo planner modules 208 and 210 supplement the spot rates offered on the price finder matrix with other rates in some systems such as the same contract rate promised under the contact for the contract customer or that rate adjusted with a margin.

Under the special circumstance mode layer, the transport systems also reposition empty freight containers (referred to as containers). In this flow, an inbound container finds an outbound load within a predetermined mileage radius, once it has been unloaded through the transport system. Repositioning begins immediately after a container has been unloaded. Because containers arriving at a destination must eventually leave, either empty or full, and the longer the containers are delayed the higher the cost, the transport systems and more specifically, the router module and cargo planner modules 208 and 210 exploit a price arbitrage automatically to generate and recommend one-time transport rates in the price matrix below the spot market that results in a balanced flow. The backhaul movement transporting freight back over some or all of the same shipping lane that the container took to reach its current location generates revenue and reduces the cost of storing empty containers. Those costs include the costs of idle trucks sitting in congested terminals due to the aggregation of empty containers, the expense in returning empty containers, and the revenue lost by an imbalanced flow. The ability to balance flow through a unitary and fully automated logistical automated service is uncommon.

Similarly, the special circumstance mode layer transporting freight back over all or part of the same route it took to get to its current location irrespective of containers. In an effort to save both time and money, the transport systems may offer reduced freight rates in the price matrix that is also below the spot market. Because the transport system serves both public and private fleets, special circumstance backhauls allow carriers to reposition their vehicles, shippers to receive discounted freight rates, and shippers to receive freight delivery without delay without relying on brokers and carriers to seek out opportunities that are often held as secrets. The opportunities are automatically rendered and made accessible via the price finder matrix.

The four layers of pricing that are part of the price finder matrix rendered in the price-finder interface may be compared against market indicator element shown as a sidebar graphic element automatically in FIG. 5. The market indicator elements render benchmark rates for the shipping lane, seasonal rate variability for the illustrated shipping lanes, illustrations of origin-destination imbalances on vehicle capacity and/or demand, near-term rate forecasts, and “buy now” or “wait” recommendation based on the layers and all or some of the information disclosed herein.

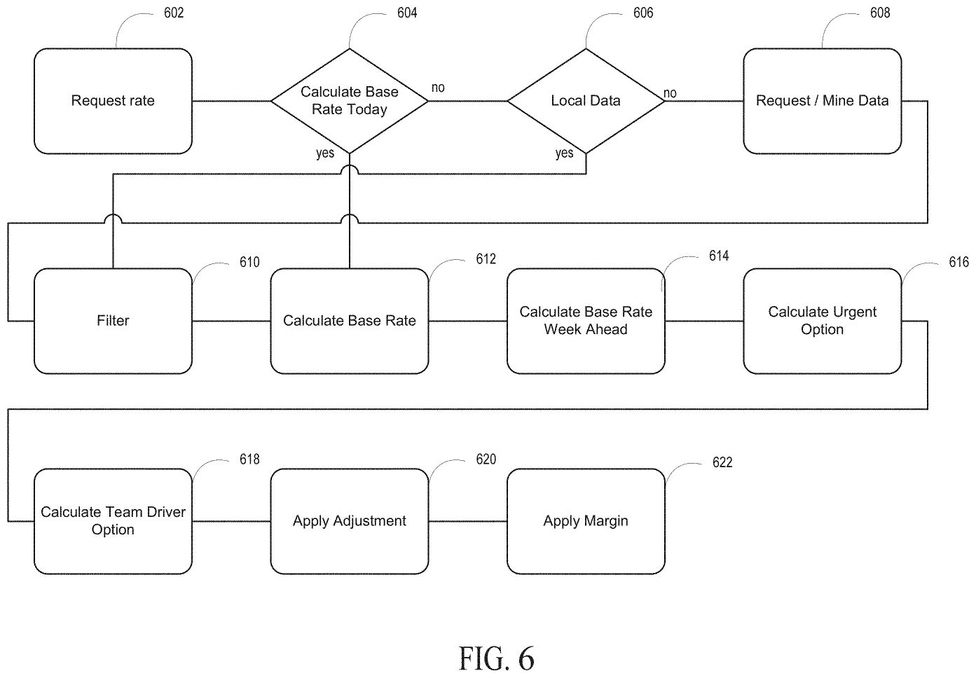

FIG. 6 illustrates an exemplary pricing algorithm requesting a rate at 602. In an FTL application, the pricing process begins by determining if the base rate has been calculated and if data it is based off of is available in a special memory subsystem in which frequently-used data values are associated with an address and are duplicated and assigned to memory addresses that provide for quick access at 604 and 606 through a direct mapping or a set-associative mapping. Set-associative memory mapping is an enhanced form of direct memory mapping where the drawbacks of direct memory mapping are removed. It does this by instead of having exactly one line that a memory block can map to in the quick access memory, the system groups a few lines together creating a set. Then a block in memory can map to any one of the lines of a specific set.

In FIG. 6, if the base rate is not available from the special memory subsystem, market averages of prevailing market averages on the prevailing spot market and contract rates as well as the historical rate and capacity trends are derived across many (e.g., it may run in the thousands) of shipping lanes. The rates are broken down by postal codes, key market areas (KMAs), predetermined radiuses in miles, and predetermined time periods (e.g., 25 miles last 7 days, 100 miles last 7 days, 15 days, 60 days, 90 days, and 365 days, and 200 miles the last 15 days) at 608. Forecasts are also made for upcoming weeks.

The exemplary pricing algorithm removes outliers by comparing monthly averages and comparing absolute values by filtering at 610. In a use case, rates should fall within about three standard deviations of the monthly average and preferably lie within ten percent of one another. In FIG. 6 the base rate is calculated as a weighted average of the market averages, forecasted averages, and in some use cases, averages of other data sources at 612. The base rate for the week ahead (a forecasted rate) is calculated using the forecast rates and each week that falls between Mondays at 614. Using the base rate and the trend, the process calculates the base rate for the week ahead.

When the urgent option is selected at 616, the calculated rate is calculated from the forecasted week ahead which is added to a predetermined premium margin. In some exemplary use cases, the premium margin ranges from about forty to sixty percent. When the team drive option is selected at 618, a premium factor is added to the computed rate of the urgent option. In the exemplary use case, a one percent margin is added to the urgent rate.

In some exemplary pricing algorithms, adjustments are applied to the base rate ahead with urgent and team drive options at 620. Each adjustment rule can be applied as an absolute vales or percent, and in some applications, encompass the filter factors described herein. Generally, the rates are applied in a first created, first applied sequence. Further, a margin is applied to base rate at 622 before an urgent or team drive option is selected.

In some transport systems, the freight visibility module 248 maintains real time communication with the carrier agent module 104 or directly with the motor carrier associated with the carrier agent module 104 to track and update the motor carrier's status, direction of travel, and progress of the shipper's load to its delivery destination. The freight visibility module 248 reports are based on direct communication with the motor carrier. The communication is used to track and update the motor carrier's transport status in real time via real time geographical maps that are rendered on a display. In some systems, the real time geographical maps show satellite imagery, aerial photography, street maps, and/or three-hundred-and-sixty-degree panoramic views of the streets the motor carrier is traveling through or parked at, weather along the route, real time traffic conditions in the shipping lanes, and the projected shipping lane congestion, and direction the motor carrier is traveling at.

In some systems communication occurs through modal interfaces that make use of truck-to-air-to-transport system transceivers to communicate directly with the visibility module 248 of the transport systems. In other alternate systems, truck-to-truck, truck-to-rail-to-truck, rail-to-sea, and truck-to-sea transceivers are used to track motor carrier transport directly to provide faster than real time communication used to track motor carrier directions, their movement, and provide notifications between them. Through the use of a parallel processing architecture and various code templates reflecting the output characteristics of mobile devices stored in a database, the transceivers may process data through a modular level adaptive transmission controllers (not shown) that deliver faster than real time encoding and multiple adaptive bit rate outputs, that deliver multiple resolutions and deliver output formats in real time or near real time to many (e.g., two or more) devices and many display form factors such the thousands of form factors and displays used in mobile devices in use today. The adaptive bit rate outputs meet compliance requirements of the output devices and are adaptable to developing requirements such as the output requirement of mobile devices and the various operating platforms, OS versions, and proliferation of features that operate on top of them.

In the transport systems and processes described above, deep and machine learning algorithms train and evaluate the fitness of the neural networks used to integrate data and make transport recommendations, such as the highlighted $1,683 recommended rate shown in FIG. 5. An exemplary neural network may comprise one or more operating layers, including convolution layers, pooling layers, normalization layers, rectified linear unit layers, etc. or any other layer that may be used in a neural network. A current layer's input/output dimensions may limit the selected hyperparameters of a layer to ranges that fall within other ranges that can be processed by the input of a subsequent layer. A next layer's input dimensions may be determined after hyperparameters of an immediately preceding layer are defined, which modifies the amount of data that can flow to the backend of the neural network models. By applying limiting rules, a constraint is generated, tracked by a training cluster, stored in memory, and applied by the training cluster servers to ensure that changes in a preceding layer or changes in the sequence of the layers is compliant with the next layer that directly follows it in terms of input and output object transfers and functions, and cascades the requirements through the backend layers.

The training process begins with the receipt of the machine-learning models to be trained. An extraction and translation process transform a portion of the training data into training vectors and the other or remaining portion of the supplemented or conditioned training data into evaluation vectors used to validate the trained models (e.g., usually a seventy-five to twenty-five percent split is used). Applying an iterative learning process, such as a stochastic gradient descent learning, some or all of the weights, layer sequences, and/or layer parameters of the neural network models are adjusted to minimize a loss function. Training may be limited to a fixed number of training cycles, periods of time, and/or until the neural network exceeds a fitness threshold.

The trained neural network is evaluated at a training cluster server by processing the evaluation vectors that are separate from and different from the training vectors. Based on the trained neural network's performance, the training cluster calculates a fitness value by executing the evaluation vectors. In some applications, a user or transport application defines the acceptable fitness level. When the fitness level is reached, the respective machine learning algorithms are trained and enter service in the systems and processes during a transport system session.

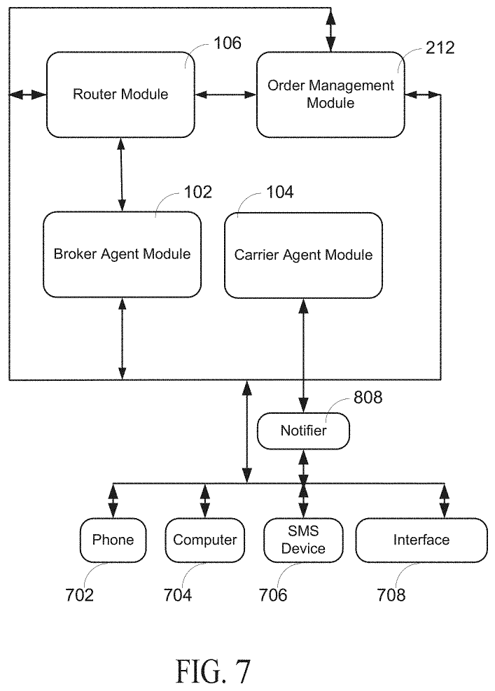

FIG. 7 is a block diagram of the transport system that may execute the system functions and process flows described above and shown in FIG. 1-6. In FIG. 7, the broker agent module 102 interfaces a notifier 808 and receives input through an application programming interface (API) that receives voice frames (e.g., speech that is translated to text by a speech-to-text-synthesis) or text though a phone 702, computer 704, short message service (SMS) device 706, computer, and/or an interface 708, such as a human machine interface (HMI).

A broker agent module 102 automatically assists shippers with freight ready to or predicted to haul by finding carriers who are qualified to haul their loads. Orders from shippers are stored in the order stack 108 in the order management module 212 and matched in the router module 106. In FIG. 7, potential carrier assignments are received by the carrier agent module 104 based on carrier orders and carrier profile details. In some systems, the functionality described herein may be executed in cloud-based systems providing an around the clock accessible fault-tolerant systems available anywhere in the world.

FIG. 8 is a block diagram of a transport system that may execute the process flows and system functionality described above and those shown in FIGS. 1-7 automatically. The system comprises a processor 802, a non-transitory media, such as a memory 804 and 806 (the contents of which are accessible and executable by the processor 802), a notifier device 808, and an I/O interface 810. The I/O interface 810 connects devices and points of interaction, such as the phone 702, the SMS enabled device 706, the computer 704 and/or the interface 708, to local and/or remote applications, such as, for example, additional local and/or remote transport services. The memory 804 and 806 store instructions, which when executed by the processor 802, causes the components to render some or all of the functionality associated with transporting and/or tracking freight. The memory 802 and 804 stores instructions, which when executed by the processor 802, causes the transport system to render the functionality associated with the customer portal 202, the carrier portal 236, the customer data modeler 204, the freight router module 208, the cargo planner module 210, the master data modules 214 and 216, the work flow engines 226, the common reference data repository 218, the metadata management module 220, the data quality management module 222, the rate miner 230, the route miner 228, the carrier order details module 234, the carrier profiles module 232, the order management module 212, the freight matching engine 802, the staged record management module 246, the freight visibility module 248, the WMS 250, the CRM 254, and the finance and accounting module 252.

The memory 804 and 806 and/or storage disclosed may retain an ordered listing of executable instructions for implementing the functions described above in a non-transitory computer code. The machine-readable medium may selectively be, but is not limited to, an electronic, a magnetic, an optical, an electromagnetic, an infrared, or a semiconductor medium. A non-exhaustive list of examples of a machine-readable medium includes: a portable magnetic or optical disk, a volatile memory, such as a Random-Access Memory (RAM), a Read-Only Memory (ROM), an Erasable Programmable Read-Only Memory (EPROM or Flash memory), or a database management system. The memory 804 and 806 may comprise a single device or multiple devices that may be disposed on one or more dedicated memory devices or disposed on a processor or other similar device. The engines may comprise a processor or a portion of a program that executes or supports recognition system or processes. When functions, steps, etc. are said to be “responsive to” or occur “in response to” another function or step, etc., the functions or steps necessarily occur as a result of another function or step, etc. It is not sufficient that a function or act merely follow or occur subsequent to another. Further, the term “engine” generally refers to a device, processor, and/or program executed by a hardware processor that manages and manipulates data as programmed to execute the functionality associated with the device. Computer-mediated technology enables human communication that occurs through two or more electronic devices. The devices may provide input from various sources including, but not limited to, audio, text, images, video, etc. A session is the time during which a program accepts input and processes information about a particular species. For transport, it may be the time during which the user transacts a freight shipment rather than the entire time the user is accessing resources on a transport site. The term “about” encompasses variances between one and five percent or an exact percent in that range that excludes other percentages in that range that may be associated with the particular variable.

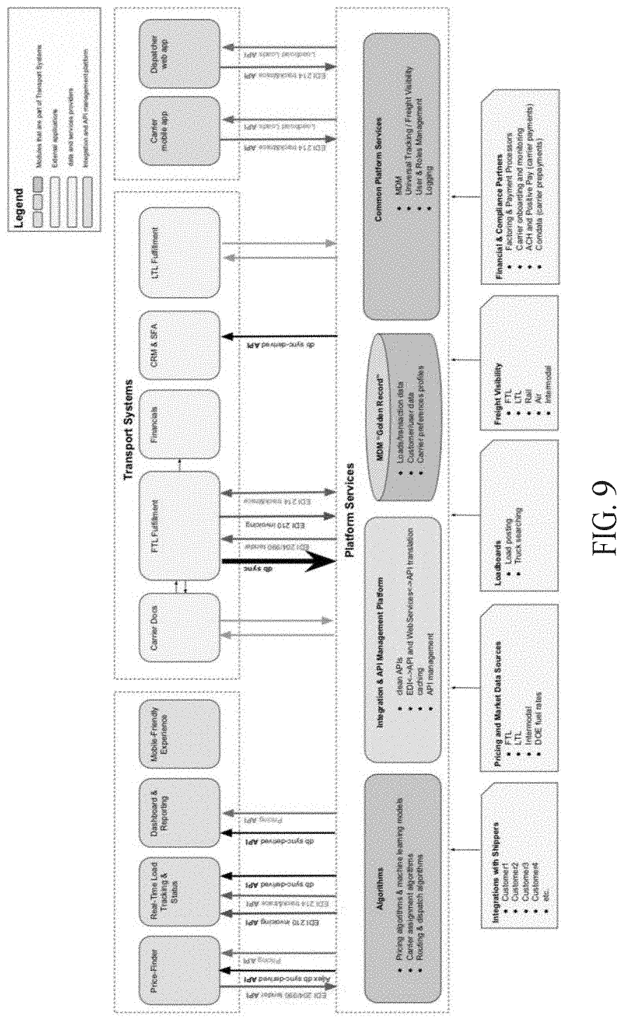

While each of the systems and methods shown and described herein operate automatically and operate independently, they also may be encompassed within other systems and methods including any number (N) of iterations of some or all of the process used to recognize input, render recognized results, and/or render an output such as a business classification, for example. Alternate transport systems may include any combination of structure and functions described or shown in one or more of the FIGS. These systems are formed from any combination of structures and functions described. The structures and functions may process the same, additional, or different input and may include the data integrations from multiple distributed sources as shown in FIG. 9 to provide real time or near real time pricing and freight visibility. The inventions disclosed herein suitably may be practiced in the absence of any element which is not specifically disclosed herein.

The functions, acts or tasks illustrated in the FIGS. or described herein may be executed in response to one or more sets of logic or instructions stored in or on non-transitory computer readable media as well. The functions, acts, or tasks are independent of the particular type of instructions set, storage media, processor or processing strategy, and may be performed by software, hardware, integrated circuits, firmware, micro code and the like, operating alone or in combination.

The disclosed systems efficiently automate the logistics of moving freight. The transport systems coordinate complex delivery routes that may include FTL, LTL, multistop/consolidation and intermodal transport. The transport systems optimize deliveries across one or more modes of transport and construct one or more transport options through one or multiple delivery legs. The development of the logistics behind the transport system is based on productivity and efficiency that ensures safe and cost-effective deliveries in a cost efficient and a time-sensitive schedule.

The disclosed systems include innovative interfaces, such as the price finder user interface, that reflect pricing rendered via a price finder matrix across different modes of transportation. The modes of transportation include FTL, LTL, multistop/consolidation, and Intermodal, for example. The price finder interface also generates forecasts that render time and/or price tradeoffs, provides special-circumstance pricing choices (such as backhauls, contract-based pricing for some lanes, container repositioning, etc., for example), and provides appointment price tradeoffs including working around the hours of service restrictions, for example.

Other systems, methods, features and advantages will be, or will become, apparent to one with skill in the art upon examination of the figures and detailed description. It is intended that all such additional systems, methods, features and advantages be included within this description, be within the scope of the disclosure, and be protected by the following claims.

What is claimed is:

1. A method of scheduling a vehicle transporting freight on a mesh network using a machine learning process comprising:
receiving transportation requests over a network from a plurality of customer portals that include loading times, loading locations, destination locations, delivery times, and freight requirements;
mining a plurality of large data sets from remote sites that reflect distances between the loading locations and the destination locations and corresponding freight rates associated with distances through the machine learning process;
predicting a plurality of shipping schedules that include predicted departure time and a predicted arrival time associated with the plurality of shipping schedules; and
matching the transportation requests with the plurality of shipping schedules in real time based on a plurality of shipping preferences, carrier availabilities, and projected probabilities that a plurality of carriers will accept loads.

2. The method of claim 1 further including generating a recommendation sequence that identified the plurality of carriers and an order and a duration in which a potential hauling assignment is proffered.

3. The method of claim 1 further comprising posting the plurality of shipping schedules through a price-finder user interface.

4. The method of claim 3 further comprising recommending one of the plurality of shipping schedules and corresponding prices.

5. The method of claim 3 where the recommending of the one of plurality shipping schedules is based on a plurality of parameters that include a vehicle transport selection, one of the loading locations, and one of the destination locations.

6. The method of claim 5 where the recommending is devoid of any other parameters.

7. The method of claim 5 where the shipping schedules include an intermodal transport and corresponding prices that are based on a repositioning of a plurality of shipping containers.

8. A non-transitory machine-readable medium encoded with machine-executable instructions for scheduling a vehicle transporting freight on a mesh network using a machine learning process, where execution of the machine-executable instructions is for:
receiving transportation requests over a network from a plurality of customer portals that include loading times, loading locations, destination locations, delivery times, and freight requirements;
mining a plurality of large data sets from remote sites that reflect distances between the loading locations and the destination locations and corresponding freight rates associated with distances through the machine learning process;
predicting a plurality of shipping schedules that include predicted departure time and a predicted arrival time associated with the plurality of shipping schedules; and
matching the transportation requests with the plurality of shipping schedules in real time based on a plurality of shipping preferences, carrier availabilities, and projected probabilities that a plurality of carriers will accept loads.

9. The non-transitory machine-readable medium of claim 8 further including generating a recommendation sequence that identified the plurality of carriers and an order and a duration in which a potential hauling assignment is proffered.

10. The non-transitory machine-readable medium of claim 8 further comprising posting the plurality of shipping schedules through a price-finder user interface.

11. The non-transitory machine-readable medium of claim 10 further comprising recommending one of the plurality of shipping schedules and corresponding prices.

12. The non-transitory machine-readable medium of claim 10 where the recommending of the one of plurality of shipping schedules is based on a plurality of parameters that include a vehicle transport selection, one of the loading locations, and one of the destination locations.

13. The non-transitory machine-readable medium of claim 12 where the recommending is devoid of any other parameters.

14. The non-transitory machine-readable medium of claim 12 where the shipping schedules include an intermodal transport.

15. The non-transitory machine-readable medium of claim 14 further including corresponding prices that are based on a repositioning of a plurality of shipping containers.

16. The non-transitory machine-readable medium of claim 12 where the shipping schedules include a multistop or consolidation transport.

17. A system that schedules a vehicle transporting freight comprising:
a customer portal for receiving transportation requests over a network from a plurality of customer portals that include loading times, loading locations, destination locations, delivery times, and freight requirements;
a mileage miner for mining a plurality of large data sets from remote sites that reflect distances between the loading locations and the destination locations through a machine learning process;
a mileage miner for mining a second plurality of large data and corresponding freight rates associated with distances through the machine learning process;
a routing module programmed to predict a plurality of shipping schedules that include predicted departure time and a predicted arrival time associated with the plurality of shipping schedules; and
a matching engine that matches the transportation requests with the plurality of shipping schedules in real time based on a plurality of shipping preferences, carrier availabilities, and projected probabilities that a plurality of carriers will accept loads.

18. The system of claim 17 where the matching engine generates a recommendation sequence that identified the plurality of carriers and an order and a duration in which a potential hauling assignment is proffered.

19. The system of claim 17 where the routing module posting the plurality of shipping schedules through a price-finder user interface.

20. The system of claim 19 where the routing module recommends one of the plurality of shipping schedules and corresponding prices.
